(19) United States
(12) Patent Application Publication
(10) Pub. No.: US 2012/0269261 A1
(43) Pub. Date: Oct. 25, 2012

(54) METHODS AND APPARATUSES FOR ENCODING AND DECODING IMAGE USING ADAPTIVE FILTERING

(75) Inventors: Byeong-doo CHOI, Siheung-si (KR); Dae-sung CHO, Seoul (KR); Seung-soo JEONG, Seoul (KR)

(73) Assignee: SAMSUNG ELECTRONICS CO., LTD., Suwon-si (KR)

(21) Appl. No.: 13/450,812

(22) Filed: Apr. 19, 2012

(30) Foreign Application Priority Data
Apr. 19, 2011 (KR) 10-2011-0036379

(51) Int. Cl. H04N 7/32

(52) U.S. Cl. 375/240.02; 375/E07.245

(57) ABSTRACT

Provided are methods and apparatuses for encoding and decoding an image by using adaptive filtering. The method of encoding an image by using adaptive filtering includes: determining a filter to be applied to a reference frame used for prediction encoding of a current block to be encoded, by adaptively changing a size and filter coefficients of the filter; filtering the reference frame by using the determined filter; prediction encoding the current block by using the filtered reference frame; and outputting data of the prediction encoded current block and information about the filter.

### CROSS-REFERENCE TO RELATED PATENT APPLICATION

This application claims priority from Korean Patent Application No. 10-2011-0036379, filed on Apr. 19, 2011 in the Korean Intellectual Property Office, the disclosure of which is incorporated herein in its entirety by reference.

### BACKGROUND

1. Field

Apparatuses and methods consistent with exemplary embodiments relate to video encoding and decoding that filters a reference frame used for prediction encoding.

2. Description of the Related Art

In image compression methods, such as moving picture experts group (MPEG)-1, MPEG-2, MPEG-4 H.264, and MPEG-4 advanced video coding (AVC), a picture is divided into image processing units, i.e., macro blocks, in order to encode an image. Then, each macro block is encoded by using inter prediction or intra prediction.

Multi-view video coding (MVC) is used to process a plurality of images having different views obtained from a plurality of cameras. Here, a multi-view image is compressed and encoded by using temporal correlation and spatial correlation of an inter-view between cameras.

In temporal prediction using temporal correlation and inter-view prediction using spatial correlation, motion of a current picture is predicted and compensated in a block unit by using at least one reference picture so as to encode an image. In the temporal prediction and inter-view prediction, a block most similar to the current block is searched within a determined search range of the reference block, and when the similar block is found, only residual data between the current block and the similar block is transmitted, thereby increasing a compression rate of data.

### SUMMARY

Aspects of exemplary embodiments provide methods and apparatuses for encoding and decoding an image, which perform adaptive filtering on a reference frame during inter prediction using the reference frame.

According to an aspect of an exemplary embodiment, there is provided a method of encoding an image by using adaptive filtering, the method including: determining a filter to be applied to a reference frame used for prediction encoding of a current block to be encoded, by adaptively changing a size and filter coefficients of the filter; filtering the reference frame by using the determined filter; prediction encoding the current block by using the filtered reference frame; and outputting the prediction encoded data of the current block and information about the filter.

According to an aspect of another exemplary embodiment, there is provided a method of decoding an image by using adaptive filtering, the method including: extracting data of a differential signal between a current block to be decoded and a corresponding block of a reference frame, and information about a filter applied to the reference frame, by parsing a received bitstream; determining a filter to be applied to the reference frame by adaptively changing a size and filter coefficients of the filter based on the extracted information about the filter; filtering the reference frame by using the determined filter; generating a prediction signal of the current block by using the filtered reference frame; and restoring the current block by adding the differential signal and the prediction signal of the current block.

According to an aspect of another exemplary embodiment, there is provided an apparatus for encoding an image by using adaptive filtering, the apparatus including: a filtering unit for determining a filter to be applied to a reference frame used for prediction encoding of a current block to be encoded, by adaptively changing a size and filter coefficients of the filter, and filtering the reference frame by using the determined filter; a prediction encoder for prediction encoding the current block by using the filtered reference frame; and an output unit for outputting the prediction encoded data of the current block and information about the filter.

According to an aspect of another exemplary embodiment, there is provided an apparatus for decoding an image by using adaptive filtering, the apparatus including: a data extractor for extracting data of a differential signal between a current block to be decoded and a corresponding block of a reference frame, and information about a filter applied to the reference frame, by parsing a received bitstream; a filtering unit for determining a filter to be applied to the reference frame by adaptively changing a size and filter coefficients of the filter based on the extracted information about the filter, and filtering the reference frame by using the determined filter; a predictor for generating a prediction signal of the current block by using the filtered reference frame; and a restoring unit for restoring the current block by adding the differential signal and the prediction signal of the current block.

### BRIEF DESCRIPTION OF THE DRAWINGS

The above and other features and advantages will become more apparent by describing in detail exemplary embodiments with reference to the attached drawings in which:

FIG. 1 is a block diagram of an image encoding apparatus according to an exemplary embodiment;

FIG. 2 is a block diagram of an image encoding apparatus according to another exemplary embodiment;

FIG. 3 is a detailed block diagram of an image encoding apparatus according to an exemplary embodiment;

FIG. 4 is a detailed block diagram of an image encoding apparatus according to another exemplary embodiment;

FIGS. 5 and 6 are graphs for illustrating characteristics of a filter according to an exemplary embodiment;

FIGS. 7A and 7B are reference diagrams for illustrating a 5×5 filter according to an exemplary embodiment;

FIGS. 8A and 8B are reference diagrams for illustrating a 3×3 filter according to an exemplary embodiment;

FIG. 9 is a reference diagram for illustrating an adaptive filter according to an exemplary embodiment;

FIG. 10 is a graph for illustrating characteristics of the adaptive filter of FIG. 9 according to values of a center filter coefficient;

FIG. 11 is a diagram for illustrating a concept of coding units according to an exemplary embodiment;

FIG. 12 is a diagram illustrating deeper coding units according to depths, and partitions, according to an exemplary embodiment;

FIG. 13 is a flowchart illustrating an image encoding method using adaptive filtering, according to an exemplary embodiment;

FIG. 14 is a block diagram of an image decoding apparatus using adaptive filtering, according to an exemplary embodiment;

FIG. 15 is a block diagram of an image decoding apparatus using adaptive filtering, according to another exemplary embodiment;

FIG. 16 is a detailed block diagram of an image decoding apparatus according to an exemplary embodiment;

FIG. 17 is a detailed block diagram of an image decoding apparatus according to another exemplary embodiment; and

FIG. 18 is a flowchart illustrating an image decoding method using adaptive filtering, according to an exemplary embodiment.

### DETAILED DESCRIPTION OF EXEMPLARY EMBODIMENTS

Hereinafter, exemplary embodiments will be described more fully with reference to the accompanying drawings.

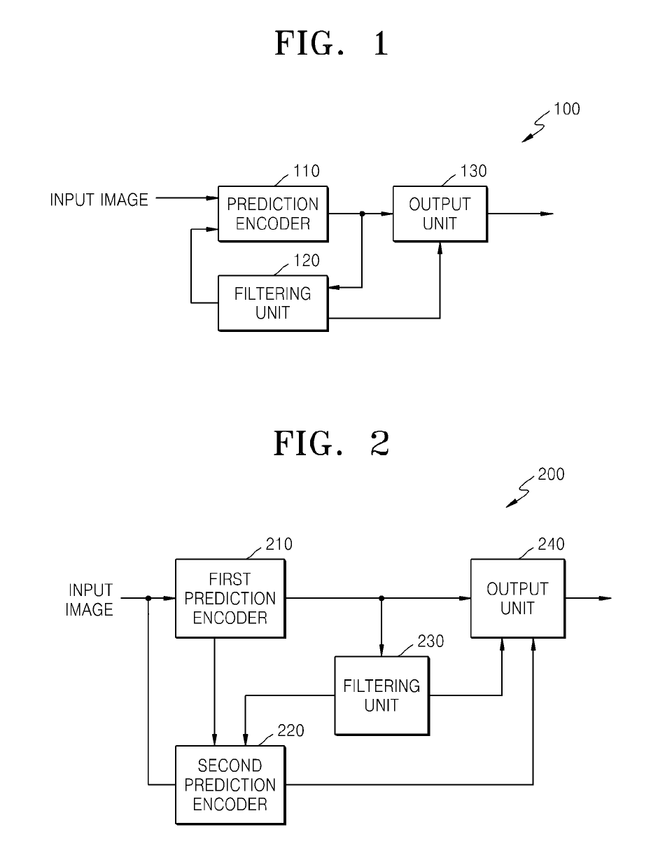

FIG. 1 is a block diagram of an image encoding apparatus 100 according to an exemplary embodiment. The image encoding apparatus 100 is an apparatus for encoding a single view image, and filters a reference frame that is pre-encoded and uses the filtered reference frame for prediction encoding as will be described below.

Referring to FIG. 1, the image encoding apparatus 100 includes a prediction encoder 110, a filtering unit 120, and an output unit 130.

The prediction encoder 110 is a general image coder which performs intra prediction encoding on a current block that is intra predicted by using an adjacent block that is pre-encoded and restored before the current block, and performs inter prediction encoding on a current block that is inter predicted by using a reference frame that is pre-encoded, restored, and then filtered by the filtering unit 120.

The filtering unit 120 determines a filter to be applied to the reference frame used for prediction encoding of the current block by adaptively changing a size and filter coefficients of the filter, and filters the reference frame by using the determined filter. A process of determining the filter by the filtering unit 120 will be described in detail below.

The output unit 130 outputs data of the prediction encoded current block and information about the filter.

FIG. 2 is a block diagram of an image encoding apparatus 200 according to another exemplary embodiment.

Referring to FIG. 2, the image encoding apparatus 200 includes a first prediction encoder 210, a second prediction encoder 220, a filtering unit 230, and an output unit 240. The image encoding apparatus 200 may be an apparatus for scalably encoding an input image to a base layer and an enhancement layer, or an apparatus for encoding images having different views, such as a multi-view image.

If the input image is scalably encoded, the first prediction encoder 210 encodes the input image to a base layer bitstream having a predetermined resolution and quality, and the second prediction encoder 220 generates an enhancement layer bitstream of higher quality by using the input image and an image of a base layer pre-encoded by the first prediction encoder 210. In other words, the second prediction encoder 220 may be an image coder device for generating an enhancement layer bitstream by using a pre-encoded and restored output image of the first prediction encoder 210 as a reference frame. The filtering unit 230 determines a filter by adaptively changing a size and filter coefficients of a filter to be applied to an image of a base layer used to generate the enhancement layer bitstream and filters the image of the base layer by using the determined filter. The output unit 240 outputs the scalably encoded base layer and enhancement layer bitstreams, and information about the filter applied to a reference frame of the base layer.

If the multi-view image is encoded, the first prediction encoder 210 first prediction encodes a first view image, such as an anchor image of the multi-view image, which is used as a reference image of images having other views. The first view image that is first encoded and restored by the first prediction encoder 210 is used as the reference image of the images having other views. The second prediction encoder 220 may be an image coder device for encoding a second view image by using the first view image pre-encoded and restored as a reference frame. The filtering unit 230 determines a filter by adaptively changing a size and filter coefficients of a filter to be applied to the first view image used to encode the second view image, and filters the first view image by using the determined filter. The output unit 240 outputs bitstreams of the encoded first and second view images and information about the filter applied to the first view image.

As described above, according to one or more exemplary embodiments, a filter is variably generated by changing a size and filter coefficients of a filter to be applied to a pre-encoded and restored reference frame used to inter predict another image in a single view, an image of a base layer used to encode an enhancement layer in scalable coding, or a pre-encoded and restored image having a predetermined view used to predict an image having another view in a multi-view image, a reference frame image is filtered by using the generated filter, and prediction encoding is performed by using the filtered reference frame image. In a related art, a fixed filter having a fixed filter coefficient is used to filter a reference frame image or all optimized filter coefficients of a filter such as a wiener filter are transmitted. However, when the fixed filter is used, it is not possible to select another efficient filter according to an image characteristic, and when all the optimized filter coefficients are transmitted, it is difficult to efficiently compress an image due to an increase in the amount of bits required to transmit the filter coefficients. Accordingly, the filtering units 120 and 230 of one or more exemplary embodiments use, instead of a fixed filter, a variable filter whose size and filter coefficient vary according to an image characteristic while transmitting predetermined information about the filter to reconstruct the filter, thereby increasing image quality and compression efficiency.

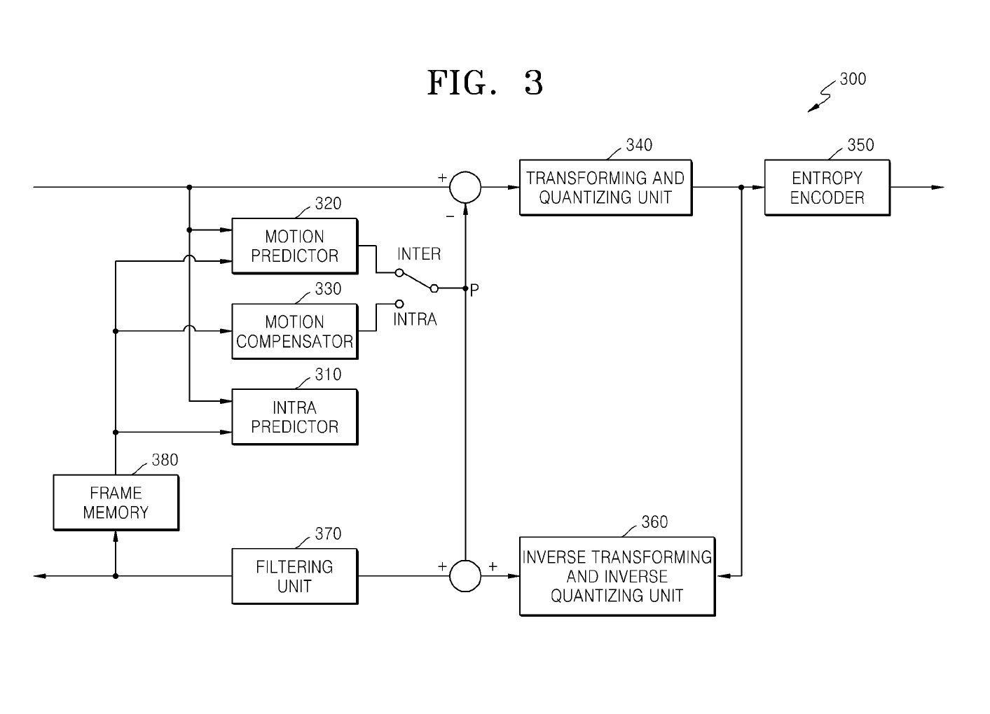

FIG. 3 is a detailed block diagram of an image encoding apparatus 300 according to an exemplary embodiment.

Referring to FIG. 3, the image encoding apparatus 300 includes an intra predictor 310, a motion predictor 320, a motion compensator 330, a transforming and quantizing unit 340, an entropy encoder 350, an inverse transforming and inverse quantizing unit 360, a filtering unit 370, and a frame memory 380.

The intra predictor 310 predicts a current block by using a pixel included in a pre-encoded region adjacent to the current block. The motion predictor 320 and the motion compensator 330 predict the current block based on at least one reference frame stored in the frame memory 380. When the motion predictor 320 generates a motion vector by searching for a block most similar to the current block in the reference frame, the motion compensator 330 motion compensates the current block based on the generated motion vector. Here, the reference frame used by the motion predictor 320 and the motion compensator 330 may be filtered by the filtering unit 370.

The transforming and quantizing unit 340 performs orthogonal transformation on a residual block, and quantizes coefficients generated as a result of orthogonal transformation according to a predetermined quantization parameter. The orthogonal transformation may be a discrete cosine transform or a Hadamard transform. The residual block is generated by subtracting a prediction block generated by the intra predictor 310 or the motion compensator 330 from the current block.

The entropy encoder 350 receives the quantized coefficients from the transforming and quantizing unit 340, and entropy encodes the quantized coefficients. The quantized coefficients are entropy encoded according to a context-based adaptive variable length code (CAVLC) or a context-based adaptive binary arithmetic code (CABAC). Also, the entropy encoder 350 may generate a bitstream by adding information about the filter determined by the filtering unit 370.

The inverse transforming and inverse quantizing unit 360 receives the quantized coefficients, and restores a residual block by inverse quantizing and inverse orthogonal transforming the received coefficients. The restored residual block is added to the prediction block to restore the current block.

The filtering unit 370 determines a filter to be applied to a pre-encoded and restored reference frame used for prediction encoding of the current block by adaptively changing a size and filter coefficients of the filter, and filters the reference frame by using the determined filter. Here, the filtering unit 370 may determine the size and filter coefficients of the filter by using an image characteristic, such as variance, of a corresponding region of a reference frame corresponding to the current block, or may filter a reference frame by applying a plurality of predetermined filters, compare rate distortion (RD) costs according to results of prediction encoding by using the filtered reference frame, and determine a filter having the least cost as a final filter to be applied to the reference frame.

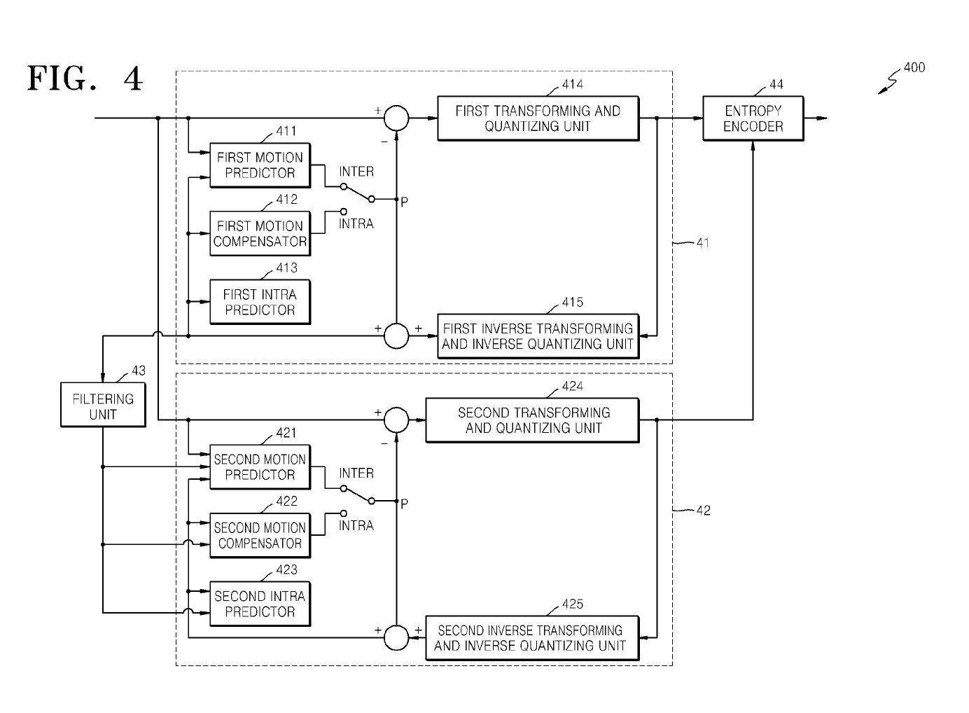

FIG. 4 is a detailed block diagram of an image encoding apparatus 400 according to another exemplary embodiment. As described above, the image encoding apparatus 400 includes a first prediction encoder 41, a second prediction encoder 42, a filtering unit 43, and an entropy encoder 44 corresponding to the output unit 240 of FIG. 2. A first intra predictor 413, a first motion predictor 411, a first motion compensator 412, a first transforming and quantizing unit 414, and a first inverse transforming and inverse quantizing unit 415 included in the first prediction encoder 41 prediction encode a base layer of a scalable image or an image having a predetermined view of a multi-view image. Also, a second intra predictor 423, a second motion predictor 421, a second motion compensator 422, a second transforming and quantizing unit 424, and a second inverse transforming and inverse quantizing unit 425 included in the second prediction encoder 42 encode an image having a different view from an image pre-encoded by the first prediction encoder 41 from among scalable images of an enhancement layer or multi-view image.

The filtering unit 43 determines a filter to be applied to a reference frame used for prediction encoding of a current block to be encoded by the second prediction encoder 42 by adaptively changing a size and filter coefficients of the filter, and filters the reference frame by using the determined filter. As described above, the filtering unit 43 may determine the size and filter coefficients of the filter by using an image characteristic, such as variance, of a corresponding region of a reference frame corresponding to the current block, or may filter a reference frame by applying a plurality of predetermined filters, compare RD costs according to results of prediction encoding by using the filtered reference frame, and determine a filter having the least cost as a final filter to be applied to the reference frame.

The entropy encoder 44 entropy encodes data encoded by the first and second prediction encoders 41 and 42 while generating a bitstream by adding information about the filter determined by the filtering unit 43.

A process of adaptively determining a filter by using a filtering unit will now be described in detail.

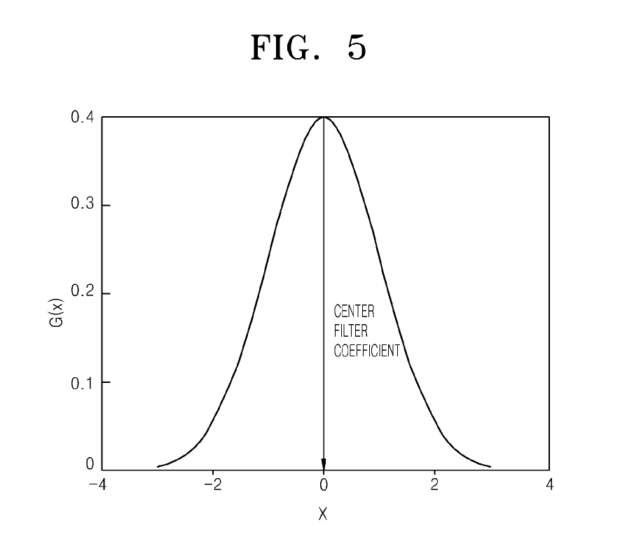

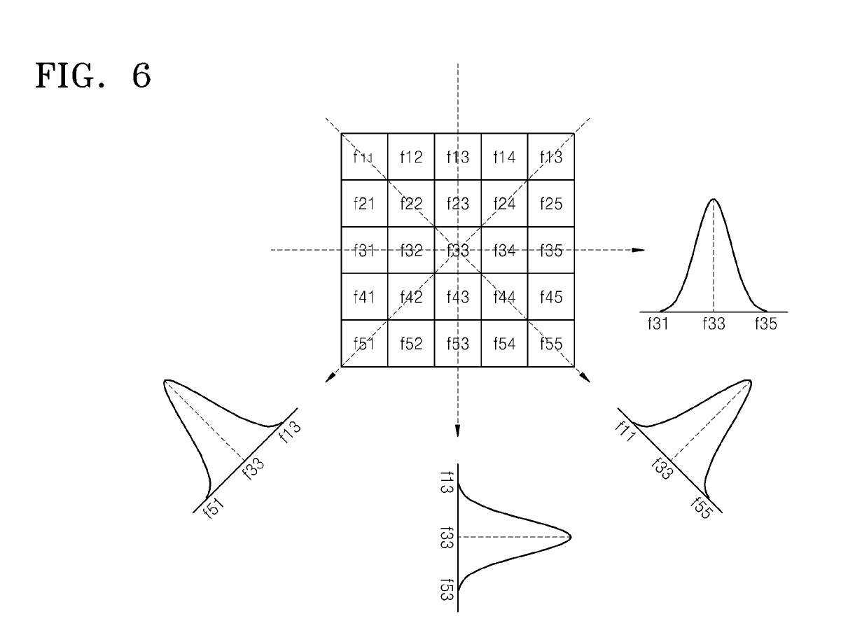

FIGS. 5 and 6 are graphs for illustrating characteristics of a filter according to an exemplary embodiment.

Referring to FIG. 5, a filter applied to a reference frame, according to an exemplary embodiment, is based on a Gaussian filter whose filter coefficients have a maximum value at a center and decrease toward the edge. In FIG. 5, 0 in an x-axis denotes the center of the filter and right and left directions of 0 denote the edges of the filter. As such, the filter bases on a Gaussian filter having the maximum filter coefficient at the center, and decreasing filter coefficients toward the edge. Referring to FIG. 6, when a filter according to an exemplary embodiment has a 5×5 size, the filter has smaller filter coefficients toward the edge based on a center filter coefficient f33 as shown.

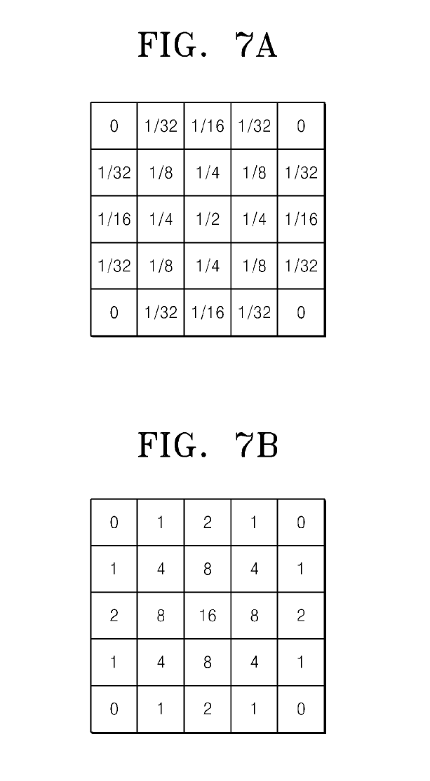

FIGS. 7A and 7B are reference diagrams for illustrating a 5×5 filter according to an exemplary embodiment. Referring to FIG. 7A, a center filter coefficient of the 5×5 filter has a value of ½, and filter coefficients of the 5×5 filter may decrease to ¼, 1/16, 1/32, and 0 toward the edge. When the filter coefficients of FIG. 7A are quantized to integers, the center filter coefficient of the 5×5 filter has a value of 16 and the filter coefficients of the 5×5 filter are decreased to 8, 4, 2, 1, and 0 toward the edge as shown in FIG. 7B. However, the filter coefficients are not limited to numbers shown in FIGS. 7A and 7B, and may change within a range satisfying conditions of a Gaussian filter whose center filter coefficient has the maximum value and filter coefficients decrease toward the edge as described above with reference to FIGS. 5 and 6.

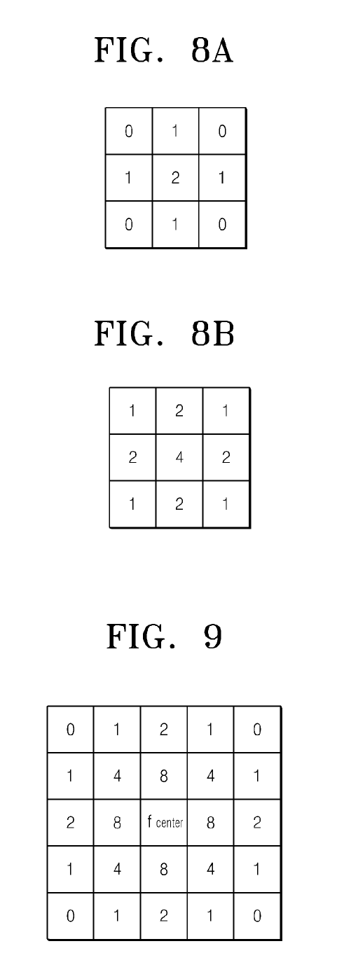

FIGS. 8A and 8B are reference diagrams for illustrating a 3×3 filter according to an exemplary embodiment. Referring to FIG. 8A, a center filter coefficient of the 3×3 filter has a value of 2, filter coefficients adjacent to the center filter coefficient have values of 1, and filter coefficients in the corner have values of 0. Referring to FIG. 8B, the center filter coefficient of the 3×3 filter has a value of 4, the filter coefficients adjacent to the center filter coefficient have values of 2, and filter coefficients in the corner have values of 1. Both 3×3 filters of FIGS. 8A and 8B are Gaussian filters.

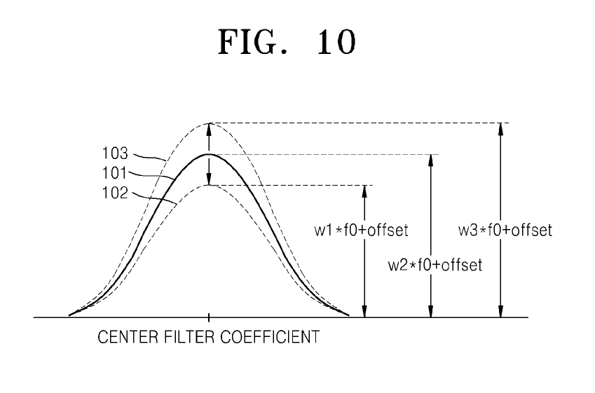

FIG. 9 is a reference diagram for illustrating an adaptive filter according to an exemplary embodiment. Referring to FIG. 9, the adaptive filter is a Gaussian filter if a center filter coefficient f_center has the maximum value. In other words, the adaptive filter is a Gaussian filter if the center filter coefficient f_center has a value higher than 8. A filtering unit according to an exemplary embodiment may change a filter applied to a reference frame by changing the value of center filter coefficient f_center from the adaptive filter of FIG. 9. The center filter coefficient f_center has a high value as a variance value of a corresponding region of the reference frame increases, and has a low value as the variance value decreases. In other words, the center filter coefficient f_center may be proportional to the variance value so as to prevent a blur phenomenon where a difference between pixels of the reference frame becomes blurred due to filtering by considering a correlation between pixels of the corresponding region of the reference frame.

As shown in FIG. 9, when various filters having a fixed size and whose center filter coefficient is changed but other filter coefficients are fixed are applied to the reference frame, efficient filtering is possible according to an image characteristic of the reference frame while transmitting only information about the center filter coefficient. Accordingly, it is possible to efficiently compress an image.

FIG. 10 is a graph for illustrating characteristics of the adaptive filter of FIG. 9 according to values of the center filter coefficient.

The center filter coefficient f center may be defined according to an equation f_center=W×f0+offset, wherein f0 denotes a basic filter coefficient, offset denotes an offset, and W denotes a weight. If f0 is a predetermined value, W and offset may be proportional to a variance value of a reference frame. For example, when VAR denotes a variance of a corresponding region of the reference frame used to predict a current block, Th1 and Th2 denote predetermined threshold values, and Th1<Th2, the center filter coefficient f_center is set to have a value of W1×f0+offset as shown by a reference numeral 102 when VAR<Th1, a value of W2×f0+offset as shown by a reference numeral 101 when Th1<VAR<Th2, and a value of W3×f0+offset as shown by a reference numeral 103 when VAR>Th2.

A filtering unit according to an exemplary embodiment adaptively filters a reference frame based on Gaussian filters having various sizes and filter coefficients. An adaptive filtering mode performed by the filtering unit may be an implicit mode or an explicit mode.

In the implicit mode, one of a plurality of filters is selected according to an image characteristic of a corresponding region of a reference frame used for prediction encoding of a current block, and only a mode information indicating the reference frame is filtered in the implicit mode is transmitted without separately transmitting information about the selected filter. For example, when a current block having a second view is prediction encoded by using a corresponding region of a reference frame having a first view, a filtering unit may calculate a variance value of the corresponding region of the reference frame having the first view and select a filter to be applied from among a plurality of filters according to a size of the variance value. As described above, since a high variance value indicates low correlation between pixels in the corresponding region of the reference frame, a filter having a large size may be determined to be applied to a current block from among the plurality of filters. Alternatively, when a filter, of which only a center filter coefficient is changed as shown in FIG. 9, is used, a filtering unit may determine a filter to be applied by selecting a center filter coefficient proportional to a variance value of a corresponding region of a reference frame. A decoder only receives mode information indicating that a reference frame of a current block is determined in an implicit mode, calculates an image characteristic of a corresponding region of a reference frame like an encoder, and determines a filter based on the calculated image characteristic.

In the explicit mode, a reference frame is filtered by applying each of a plurality of pre-prepared filters without considering an image characteristic of a corresponding region of a reference frame used for prediction encoding of a current block, costs according to results of prediction encoding are compared by using the filtered reference frame according to each filter, a filter used to generate a prediction image having the least cost is determined as a filter to be applied to the reference frame, and index information about the determined filter is separately added to a bitstream to be transmitted. A decoder may select one of a plurality of pre-prepared filters by using index information included in a bitstream to filter a reference frame.

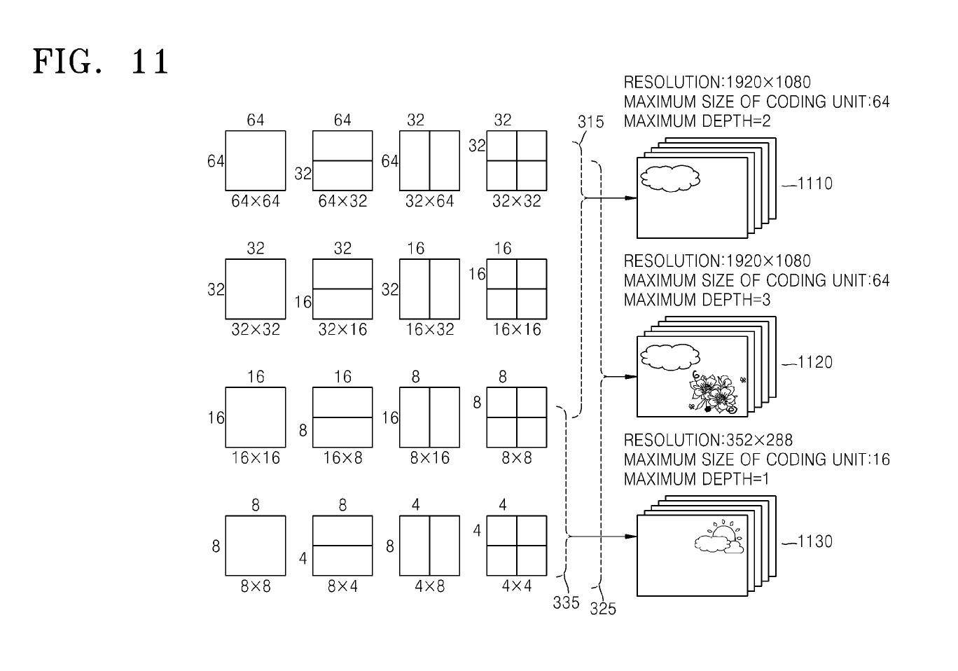

FIG. 11 is a diagram for illustrating a concept of coding units according to an exemplary embodiment.

An image encoding apparatus may form coding units having a tree structure by determining coding units having an optimum shape and an optimum size for each maximum coding unit, based on a size of the maximum coding unit and a maximum depth determined considering characteristics of a current picture. Also, since encoding may be performed on each maximum coding unit by using any one of various prediction modes and transformations, an optimum encoding mode may be determined considering characteristics of the coding unit of various image sizes.

A size of a coding unit may be expressed in width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 1110 of the present exemplary embodiment, a resolution is 1920×1080, a maximum size of a coding unit is 64, and a maximum depth is 2. In video data 1120 of the present exemplary embodiment, a resolution is 1920×1080, a maximum size of a coding unit is 64, and a maximum depth is 3. In video data 1130 of the present exemplary embodiment, a resolution is 352×288, a maximum size of a coding unit is 16, and a maximum depth is 1. The maximum depth shown in FIG. 11 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 1110 and 1120 having a higher resolution than the video data 1130 may be 64.

Since the maximum depth of the video data 1110 is 2, coding units 315 of the vide data 1110 may include a maximum coding unit having a longest axis of 64, and coding units having longest axis of 32 and 16 since depths are deepened to two layers by splitting the maximum coding unit twice. Meanwhile, since the maximum depth of the video data 1130 is 1, coding units 335 of the video data 1130 may include a maximum coding unit having a longest axis of 16, and coding units having a longest axis of 8 since depths are deepened to one layer by splitting the maximum coding unit once.

Since the maximum depth of the video data 1120 is 3, coding units 325 of the video data 1120 may include a maximum coding unit having a longest axis size of 64, and coding units having longest axis of 32, 16, and 8 since the depths are deepened to 3 layers by splitting the maximum coding unit three times. As a depth deepens, detailed information may be precisely expressed.

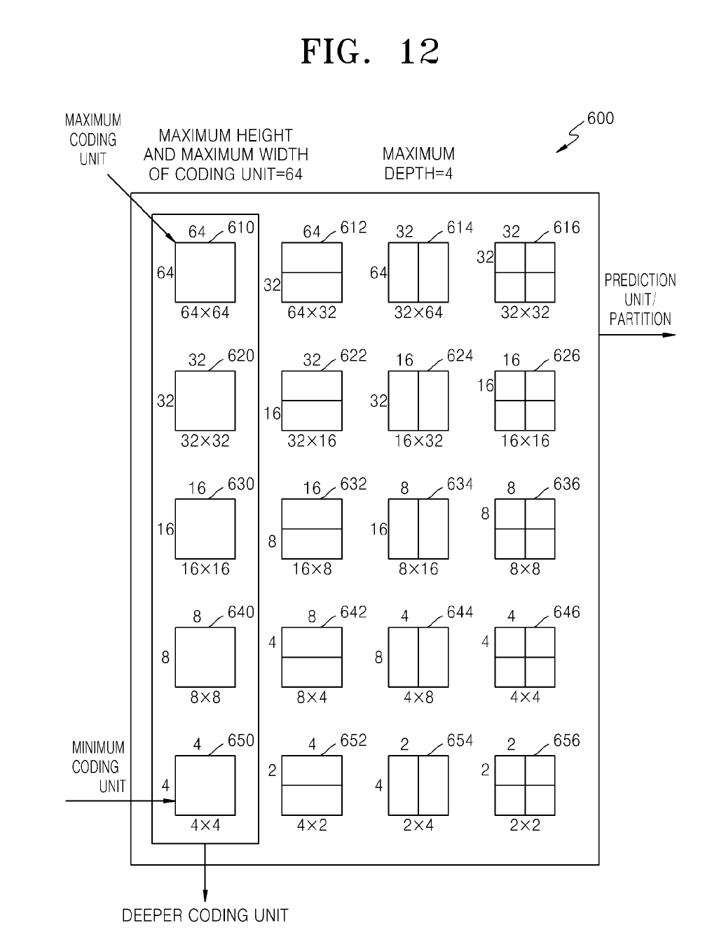

FIG. 12 is a diagram illustrating deeper coding units according to depths, and partitions, according to an exemplary embodiment.

Image encoding and decoding apparatuses according to exemplary embodiments use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to an exemplary embodiment, the maximum height and the maximum width of the coding units are each 64, and the maximum depth is 4. Here, the maximum depth indicates the total number of splitting from the maximum coding unit to the minimum coding unit. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the encoding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e., a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e., a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e., a partition having a size of 8×8 included in the coding unit 640, partitions 642 having a size of 8×4, partitions 644 having a size of 4×8, and partitions 646 having a size of 4×4.

Finally, the coding unit 650 having the size of 4×4 and the depth of 4 is the minimum coding unit and a coding unit of the lowermost depth. A prediction unit of the coding unit 650 may be only assigned to a partition having a size of 4×4. Also, the prediction unit of the coding unit 650 may include partitions 652 having a size of 4×2, partitions 654 having a size of 2×4, or partitions 656 having a size of 2×2.

Information about a filter determined by a filtering unit may be set in a coding unit, a maximum coding unit, a slice, a frame, a picture, or an image sequence unit. Also, in an implicit mode, filtering mode information indicating that a corresponding region of a reference frame is filtered in an implicit mode is further included in the information about the filter, and in an explicit mode, information about a center filter coefficient may be further included aside from filtering mode information indicating that the corresponding region is filtered in an explicit mode. Here, the information about center filter coefficient may include weight and offset information multiplied to a basic filter coefficient. Alternatively, a filtering unit may divide a current block into predetermined sub blocks, and compare RD costs of bitstreams that are a result of selectively using a reference frame filtered according to each sub block to selectively use the reference frame filtered according to each sub block. Here, index information indicating whether to use the reference frame filtered according to each sub block in a tree structure may be further included in the information about the filter.

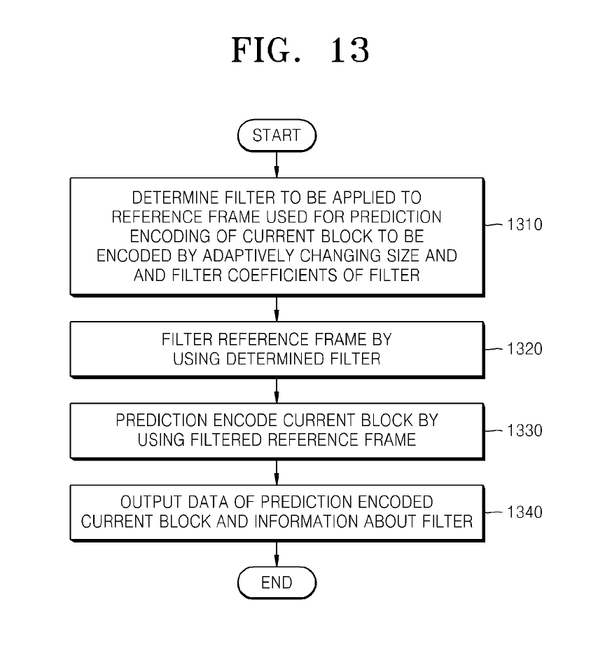

FIG. 13 is a flowchart illustrating an image encoding method using adaptive filtering, according to an exemplary embodiment of.

Referring to FIG. 13, a filter to be applied to a reference frame used for prediction encoding of a current block to be encoded is determined by adaptively changing a size and filter coefficients of the filter, in operation 1310.

A filtering unit filters the reference frame by using the determined filter, in operation 1320.

A prediction encoder prediction encodes a current block by using the filtered reference frame, in operation 1330.

An output unit outputs data of the prediction encoded current block and information about the filter, in operation 1340.

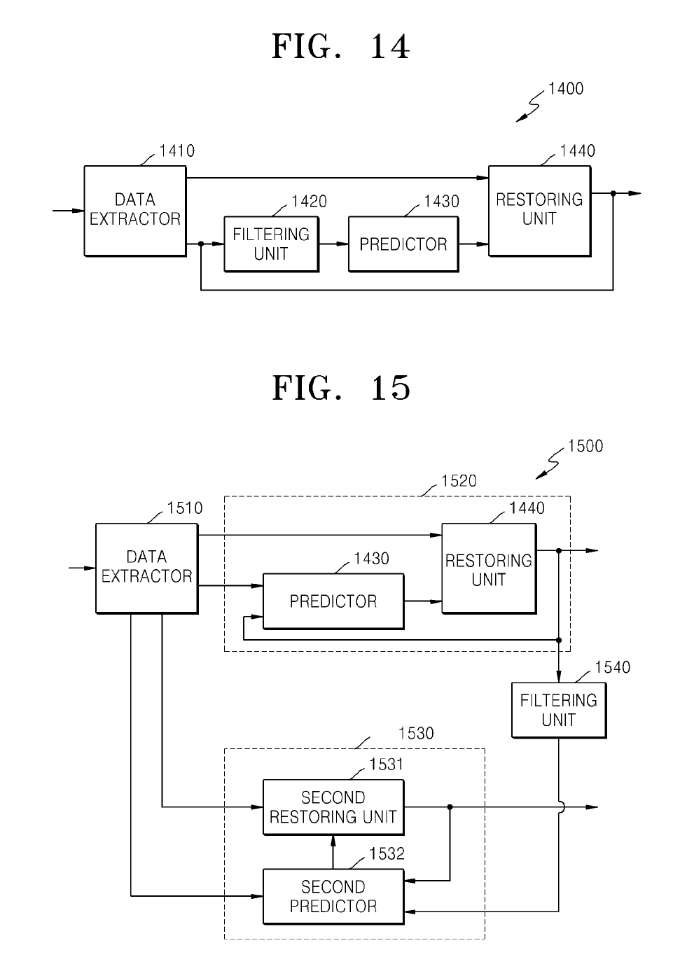

FIG. 14 is a block diagram of an image decoding apparatus 1400 using adaptive filtering, according to an exemplary embodiment.

The image decoding apparatus 1400 may correspond to the image encoding apparatus 100 of FIG. 1, and includes a data extractor 1410, a filtering unit 1420, a predictor 1430, and a restoring unit 1440.

The data extractor 1410 extracts data of a differential signal between a current block to be decoded and a corresponding block of a reference frame and information about a filter applied to the reference frame by parsing a received bitstream.

The filtering unit 1420 determines the filter to be applied to the reference frame by adaptively changing a size and filter coefficients of the filter based on the extracted information, and filters the reference frame by using the determined filter. The predictor 1430 generates a prediction signal of the current block by using the filtered reference frame. The restoring unit 1440 restores the current block by adding the extracted differential signal and the prediction signal of the current block.

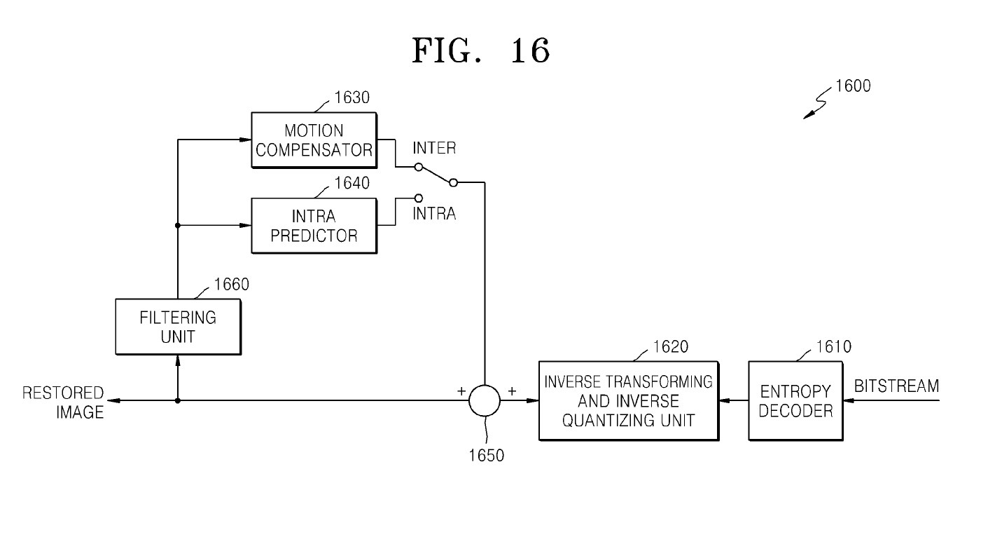

FIG. 15 is a block diagram of an image decoding apparatus 1500 using adaptive filtering, according to another exemplary embodiment.

The image decoding apparatus 1500 may correspond to the image encoding apparatus 200 of FIG. 2, and includes a data extractor 1510, a first decoder 1520, a second decoder 1530, and a filtering unit 1540. The image decoding apparatus 1500 may be an apparatus for scalably decoding an encoded bitstream in a base layer and an enhancement layer, or an apparatus for decoding a multi-view image bitstream.

If the scalably encoded bitstream is decoded, the first decoder 1520 decodes an image of the base layer included in the encoded bitstream. Since operations thereof are similar to the predictor 1430 and the restoring unit 1440 of FIG. 14, details thereof will not be repeated here. The image of the base layer decoded by the first decoder 1520 is used to decode an image of the enhancement layer. The filtering unit 1540 determines a filter to be applied to a reference frame of the base layer by adaptively changing a size and filter coefficients of the filter based on the information about the filter extracted by the data extractor 1510, and filters the reference frame by using the determined filter. The second decoder 1530 decodes the image of the enhancement layer by using the filtered image of the base layer. Similarly, when the multi-view image bitstream is decoded, the first decoder 1520 decodes a first view image, and the filtering unit 1540 determines a filter to be applied to a reference frame constituting an image of the base layer by adaptively changing a size and filter coefficients of the filter based on the information about the filter extracted by the data extractor 1510, and filters the decoded first view image by using the determined filter. The second decoder 1530 decodes a second view image based on the decoded first view image.

FIG. 16 is a detailed block diagram of an image decoding apparatus 1600 according to an exemplary embodiment.

Referring to FIG. 16, the image decoding apparatus 1600 includes an entropy decoder 1610, an inverse transforming and inverse quantizing unit 1620, a motion compensator 1630, an intra predictor 1640, and a filtering unit 1660.

The entropy decoder 1610 receives a bitstream, and extracts data of a differential signal between a current block to be decoded and a corresponding block of a reference frame and information about a filter applied to the reference frame by entropy decoding the received bitstream. The inverse transforming and inverse quantizing unit 1620 restores a residual block of the current block by performing inverse orthogonal transformation and inverse quantization on the data extracted by the entropy decoder 1610. The motion compensator 1630 inter predicts the current block by using the reference frame filtered by the filtering unit 1660 based on a motion vector of the current block. The intra predictor 1640 intra predicts the current block by using pixels included in a pre-decoded region adjacent to the current block. The current block is restored by adding the prediction block generated by the motion compensator 1630 or intra predictor 1640 and the residual block restored by the inverse transforming and inverse quantizing unit 1620.

The filtering unit 1660 determines the filter to be applied to the reference frame based on the extracted information about the filter, and filters the reference frame by using the determined filter. As described above, the filtering unit 1660 may determine the size and filter coefficients of the filter by using an image characteristic, such as a variance, of the corresponding region of the reference frame, or compare RD costs according to results of prediction encoding by using the reference frames filtered by applying a plurality of predetermined filters and determine a filter having the least cost as the filter to be applied to the reference frame.

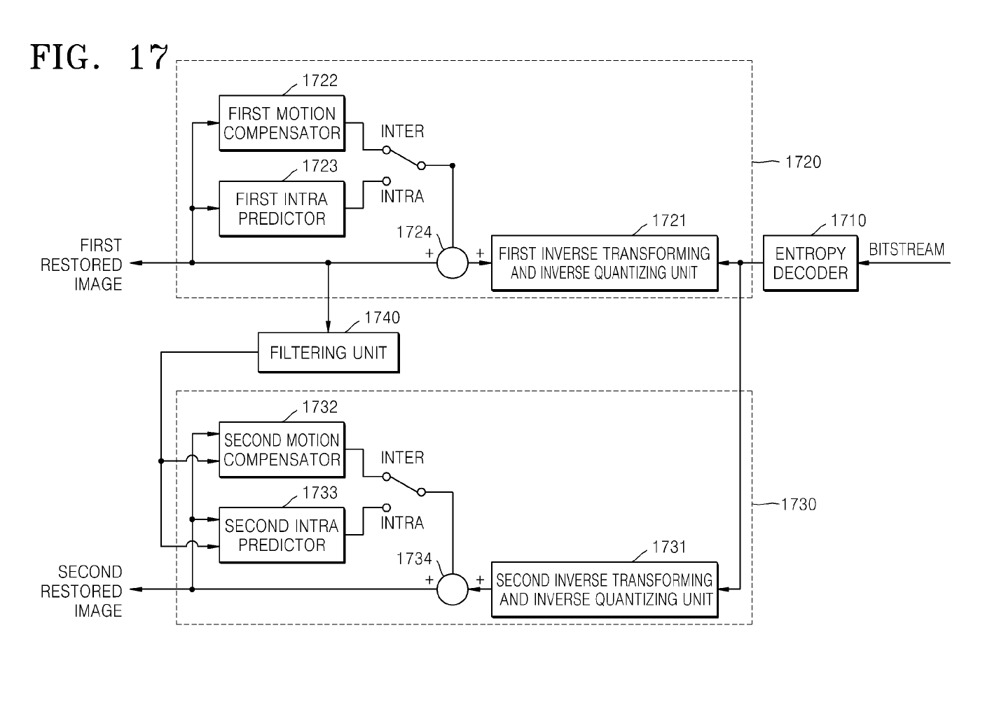

FIG. 17 is a detailed block diagram of an image decoding apparatus 1700 according to another exemplary embodiment. The image decoding apparatus 1700 includes an entropy decoder 1710, a first decoder 1720, a second decoder 1730, and a filtering unit 1740. A first motion compensator 1722, a first inverse transforming and inverse quantizing unit 1721, and a first intra predictor 1723 included in the first decoder 1720 decodes a base layer of a scalable image or a predetermined view image of a multi-view image. A second intra predictor 1733, a second motion compensator 1732, and a second inverse transforming and inverse quantizing unit 1731 included in the second decoder 1730 decodes an image of an enhancement layer of a scalable image or an image having a different view from the image pre-decoded by the first decoder 1720 from among the multi-view image.

The filtering unit 1740 determines a filter to be applied to the reference frame used for prediction of the current block decoded by the second decoder 1730 by adaptively changing a size and filter coefficients of the filter based on information about the filter extracted by the entropy decoder 1710 and filters the reference frame by using the determined filter.

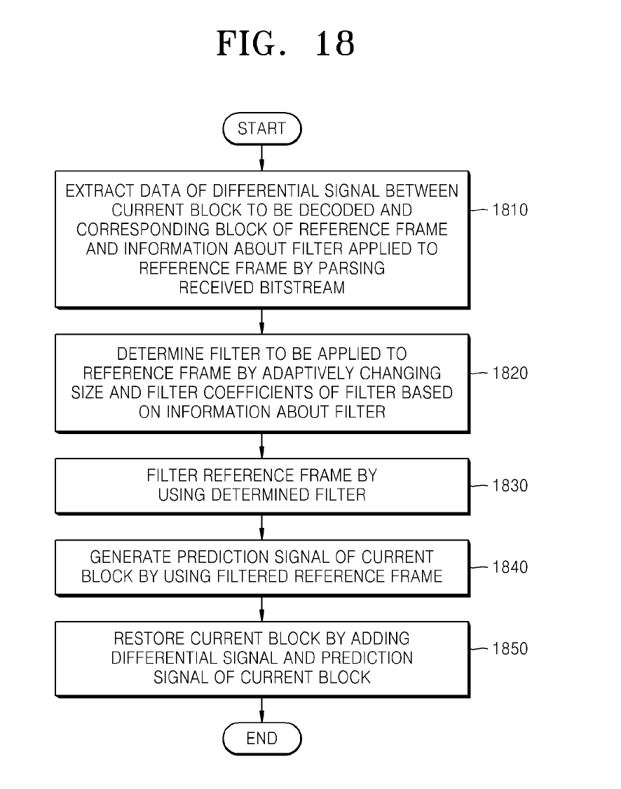

FIG. 18 is a flowchart illustrating an image decoding method using adaptive filtering, according to an exemplary embodiment.

Referring to FIG. 18, a data extractor extracts data of a differential signal between a current block to be decoded and a corresponding block of a reference frame and information about a filter applied to the reference frame by parsing a received bitstream, in operation 1810.

A filtering unit determines a filter to be applied to the reference frame by adaptively changing a size and filter coefficients of the filter based on the extracted information about the filter, in operation 1820.

The filtering unit filters the reference frame by using the determined filter in operation 1830.

A predictor generates a prediction signal of the current block by using the filtered reference frame in operation 1840.

A restoring unit restores the current block by adding a differential signal and the prediction signal of the current block in operation 1850.

According to exemplary embodiments, a reference frame is filtered by applying a suitable filter according to an image characteristic and prediction encoding is performed by using the filtered reference frame while only partial information about the filter is transmitted, thereby increasing compression efficiency of an image.

Exemplary embodiments can be written as computer programs and can be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs). Moreover, one or more of the above-described units can include a processor or microprocessor executing a computer program stored in a computer-readable medium.

While exemplary embodiments have been particularly shown and described above, it will be understood by those of ordinary skill in the art that various changes in form and details may be made therein without departing from the spirit and scope of the inventive concept as defined by the appended claims. The exemplary embodiments should be considered in a descriptive sense only and not for purposes of limitation. Therefore, the scope of the invention is defined not by the detailed description of exemplary embodiments, but by the appended claims, and all differences within the scope will be construed as being included in the present invention.

What is claimed is:

1. A method of encoding an image by using adaptive filtering, the method comprising:
determining a filter by adaptively changing a size and filter coefficients of the filter, the filter to be applied to a reference frame used for prediction encoding of a current block to be encoded;
filtering the reference frame by using the determined filter;
prediction encoding the current block by using the filtered reference frame; and
outputting the prediction encoded current block and information about the filter.

2. The method of claim 1, wherein the determining the filter comprises determining the filter according to an image characteristic of a corresponding region of the reference frame used for the prediction encoding the current block.

3. The method of claim 2, wherein the image characteristic of the corresponding region of the reference frame is a variance.

4. The method of claim 3, wherein the determining the filter according to the image characteristic comprises selecting a filter having a smallest size from among pre-determined filters as a variance value increases, and selecting a filter having a largest size from among the pre-determined filters as the variance value decreases.

5. The method of claim 3, wherein the determining the filter according to the image characteristic comprises setting a center filter coefficient from among coefficients of the filter to have a large value as a variance value increases, and setting the center filter coefficient to have a small value as the variance value decreases.

6. The method of claim 5, wherein the center filter coefficient f_center is defined according to f_center=W×f0+offset, where f0 denotes a basic filter coefficient, offset denotes an offset, and W denotes a weight, and f0 and offset are proportional to the variance value.

7. The method of claim 1, wherein the filter is a Gaussian filter.

8. The method of claim 1, wherein the determining the filter comprises:
filtering the reference frame by applying a plurality of filters having different sizes and different filter coefficients; and
comparing costs according to a result of prediction encoding the current block by using the reference frame filtered by applying the plurality of filters, and determining a filter having a least cost as the filter to be applied to the reference frame.

9. The method of claim 1, wherein:
the determining the filter comprises determining whether to perform filtering on a predetermined data unit of the reference frame; and
the predetermined data unit comprises at least one of a coding unit, a maximum coding unit, a slice, a frame, a picture, and an image sequence, and the information about the filter comprises information about whether to perform filtering on the predetermined data unit.

10. A method of decoding an image by using adaptive filtering, the method comprising:
extracting, by parsing a received bitstream, data of a differential signal between a current block to be decoded and a corresponding block of a reference frame, and information about a filter applied to the reference frame;
determining a filter to be applied to the reference frame by adaptively changing a size and filter coefficients of the filter based on the extracted information about the filter;
filtering the reference frame by using the determined filter;
generating a prediction signal of the current block by using the filtered reference frame; and
restoring the current block by adding the differential signal and the prediction signal of the current block.

11. The method of claim 10, wherein the determining the filter comprises determining the filter according to an image characteristic of a corresponding region of the reference frame used for prediction encoding of the current block.

12. The method of claim 11, wherein the image characteristic of the corresponding region of the reference frame is a variance.

13. The method of claim 12, wherein the determining the filter according to the image characteristic comprises selecting a filter having a smallest size from among pre-determined filters as a variance value increases, and selecting a filter having a largest size from among the pre-determined filters as the variance value decreases.

14. The method of claim 12, wherein the determining the filter according to the image characteristic comprises setting a center filter coefficient from among coefficients of the filter to have a high value as a variance value increases, and setting the center filter coefficient to have a small value as the variance value decreases.

15. The method of claim 13, wherein the center filter coefficient f_center is defined according to f_center=W×f0+offset, where f0 denotes a basic filter coefficient, offset denotes an offset, and W denotes a weight, and f0 and offset are proportional to the variance value.

16. The method of claim 15, wherein:
the information about the filter comprises information about a size of the filter applied to the reference frame, W, and offset; and
the determining the filter according to the image characteristic comprises determining the center filter coefficient f center based on the extracted information about the filter.

17. The method of claim 10, wherein the filter is a Gaussian filter.

18. The method of claim 10, wherein:
the determining the filter comprises determining whether to perform filtering on a predetermined data unit of the reference frame; and
the predetermined data unit comprises at least one of a coding unit, a maximum coding unit, a slice, a frame, a picture, and an image sequence, and the information about the filter comprises information about whether to perform the filtering on the predetermined data unit.

19. An apparatus for encoding an image by using adaptive filtering, the apparatus comprising:
a filtering unit which determines a filter to be applied to a reference frame by adaptively changing a size and filter coefficients of the filter and filtering the reference frame by using the determined filter, the reference frame used for prediction encoding of a current block to be encoded;
a prediction encoder which prediction encodes the current block by using the filtered reference frame; and
an output unit which outputs the prediction encoded data of the current block and information about the filter.

20. An apparatus for decoding an image by using adaptive filtering, the apparatus comprising:
a data extractor which extracts, by parsing a received bitstream, data of a differential signal between a current block to be decoded and a corresponding block of a reference frame, and information about a filter applied to the reference frame;
a filtering unit which determines a filter to be applied to the reference frame by adaptively changing a size and filter coefficients of the filter based on the extracted information about the filter, and filtering the reference frame by using the determined filter;
a predictor which generates a prediction signal of the current block by using the filtered reference frame; and
a restoring unit which restores the current block by adding the differential signal and the prediction signal of the current block.

21. A computer readable recording medium having recorded thereon a program executable by a computer for performing the method of claim 1.

22. A computer readable recording medium having recorded thereon a program executable by a computer for performing the method of claim 10.
